(19) United States
(12) Patent Application Publication
(10) Pub. No.: US 2007/0285053 A1
(43) Pub. Date: Dec. 13, 2007

(54) Portable charger

(75) Inventors: Mei Noguchi, Westfield, NJ (US); Ming-Chun Li, Zhong Shan City (CN)

Correspondence Address: VOLPE AND KOENIG, P.C., UNITED PLAZA, SUITE 1600, 30 SOUTH 17TH STREET, PHILADELPHIA, PA, 19103, US

(73) Assignee: Teledex, Inc., Kenilworth, NJ (US)

(21) Appl. No.: 11/451,167

(22) Filed: Jun. 12, 2006

(51) Int. Cl. H02J 7/00

(52) U.S. Cl. 320/114

(57) ABSTRACT

A portable power storage device for powering electronic devices especially those configured for receiving power from a 9 volt DC adapter source and configured to generate its own power through a fully self-contained, manually operable power generator. A switch-controlled flashlight utilizing a LED is also provided. The internal rechargeable battery may be recharged through either the power generator or DC power source coupled to the device through respective input connectors. Indicators provide the charging status of the power backup source. The flashlight, in another embodiment, is configured to be turned on responsive to a motion sensor as well as being configured to turn on under control of an ambient light sensor. Audio and visual alarms may also be utilized. An SOS mode is provided to generate an SOS alarm which is set to operate over a given time interval.

### FIELD OF INVENTION

The present invention relates to portable chargers and more particularly to a portable charger having a backup power pack capable of retaining a charge for a long period of time and including a manually operable charge generator and being capable of charging a variety of portable electronic devices.

### BACKGROUND

Many of today's portable convenience devices such as cell phones, PDAs, Ipods, PSPs and the like are typically, if not exclusively, battery-operated and preferably contain a small, often rechargeable, battery, housed within the portable device. The battery of such devices typically provides the power for about one day, or less. It is thus necessary to recharge the chargeable battery, most often during overnight hours, in readiness for use the next day. Recharging is performed either by coupling an AC/DC converter to a conventional outlet such as a 115 v AC outlet and to a DC input provided on the portable device, the AC/DC charger converting the AC power to DC power and an appropriate voltage level, usually of the order of 5 volts DC. Nevertheless, there arises a number of occasions and situations in which it is inconvenient and even impractical or impossible to obtain a local AC outlet. Such occasions may occur during camping or when traveling or otherwise out of doors or away from a convenient AC outlet. It is thus desirable to provide a device which is small, portable and preferably hand-held and which is capable of providing reserve power to a portable device. In addition, it is typical for technology oriented people to have one or more such portable, battery-operated devices and it is further advantageous to provide a portable charging device capable of providing backup power to plurality of different types of such portable devices, which are simply and easily connected to the charging device.

### SUMMARY

The present invention is characterized by comprising a portable power source capable of providing power to a variety of different portable devices to provide power to such devices under emergency situations as well as in situations where an AC power source for charging the rechargeable battery of a portable device is either unavailable or cannot be located or is inconvenient to access.

The device is provided with an internal, rechargeable battery capable of providing up to 1 hour of video and 5 hours of music playtime on an Ipod® , and over five (5) hours of talk time and up to two (2) days of standby time on a portable cell phone.

The internal battery, when fully charged, will hold the full charge for at least two (2) weeks.

The portable backup device is provided with a USB power output which is configured to interface with a broad variety of power connector tips to accommodate a wide variety of portable electronic devices having an internal portable battery. The device of the present invention may be utilized to provide backup power for portable electronic devices that utilize rechargeable batteries or as a 5V DC power supply to some electronic devices.

In still another embodiment of the present invention, the portable device is provided with a manually operable electric power generator contained within the housing of the device and having a manually operable crank capable of providing of the order of five (5) minutes of talk time for each two (2) minutes of cranking and in which the manually generated power is reserved for later use. The rechargeable battery pack can be recharged through the use of a DC input port provided along the exterior of the housing and coupled to the DC output of an AC adapter, as well as being configured to receive an adaptor of the type used in automobiles and which is typically inserted into the electric lighter socket or other similar DC power socket provided in an automobile or other vehicle.

In still another embodiment, the portable device may be provided with a powerful light source comprised of at least one light emitting diode (LED) which functions as both a flashlight and a nightlight. The portable charging device is provided with a motion detector which detects motion within a range of the order of 12 feet and turn on the LED light for safety, avoiding the need to look for a switch in the dark. In addition, the portable charging device may be provided with a light sensor to turn on the LED when ambient light falls below a given threshold.

All of the aforementioned charging devices may be utilized in both indoor and outdoor environments and are especially adapted for outdoor use due to their compact, light-weight and rugged design. The unit is further designed to be splash-proof, making it extremely advantageous for use when traveling or at a campsite and may be used in automobiles, SUVs and RVs as well as various water craft.

The unit also provides an “SOS siren” function, generating a 100 dB alert sound for emergency situations.

### BRIEF DESCRIPTION OF THE DRAWING(S)

The present invention will be better understood from a consideration of the detailed description and the accompanying drawings, wherein like elements are designated by like numerals, and wherein:

FIGS. 1A thru 1E are perspectives views of one preferred embodiment of the present invention configured to incorporate a backup rechargeable battery, motion detector, photoelectric sensor, light and alarm and a power generator having a manually operated crank arm which collapses into the unit housing when not in use and which contributes to the compactness and size of the unit when the crank arm is fully stored in the housing.

FIG. 2A shows a simplified block diagram of the power backup device of FIGS. 1A-1E and FIG. 2B is a detailed schematic therefor.

FIGS. 3A-3C are detailed views of the driving mechanism contained in the housing of the embodiment of FIGS. 1A-1E, FIGS. 3A and 3C showing views looking in the direction of the left-hand and right-hand sides of FIG. 3B.

FIGS. 4A-4F are views showing the front, back, sides, top and bottom of another preferred embodiment of the present invention.

FIG. 5 is a schematic diagram of the electronics provided in the embodiment of FIGS. 4A-4F.

### DETAILED DESCRIPTION OF THE INVENTION AND THE PREFERRED EMBODIMENTS THEREOF

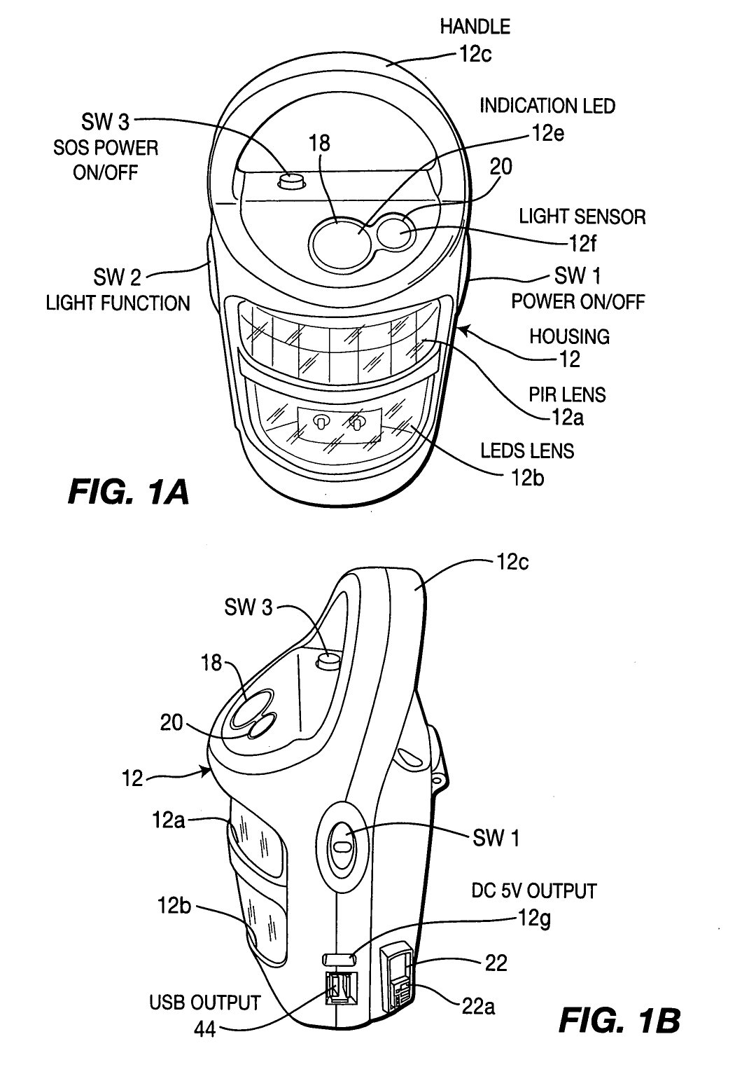

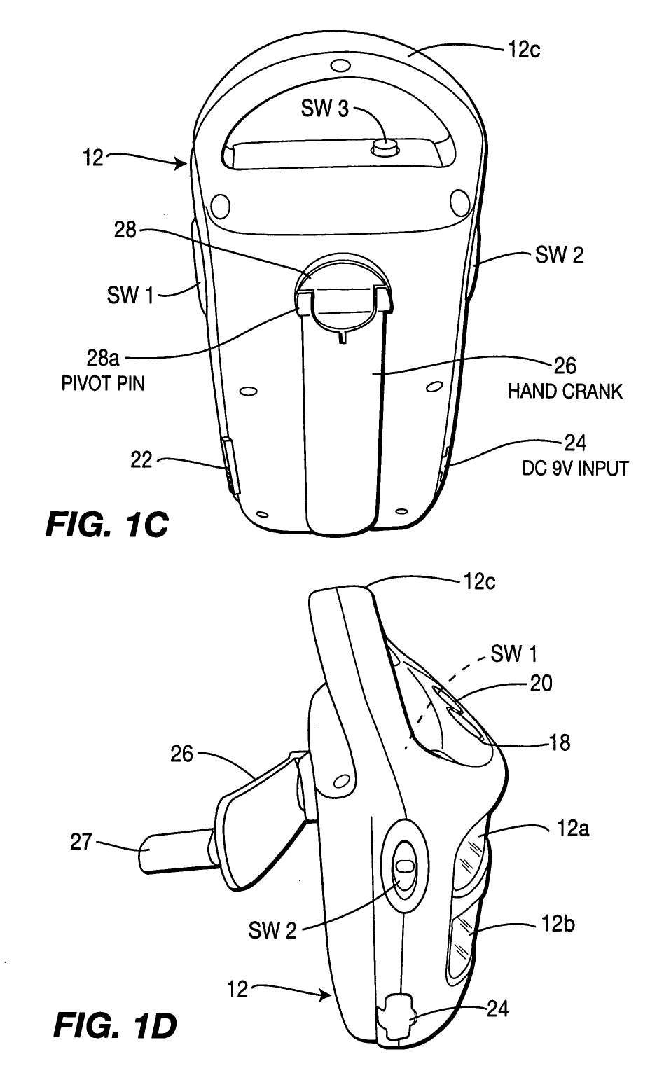

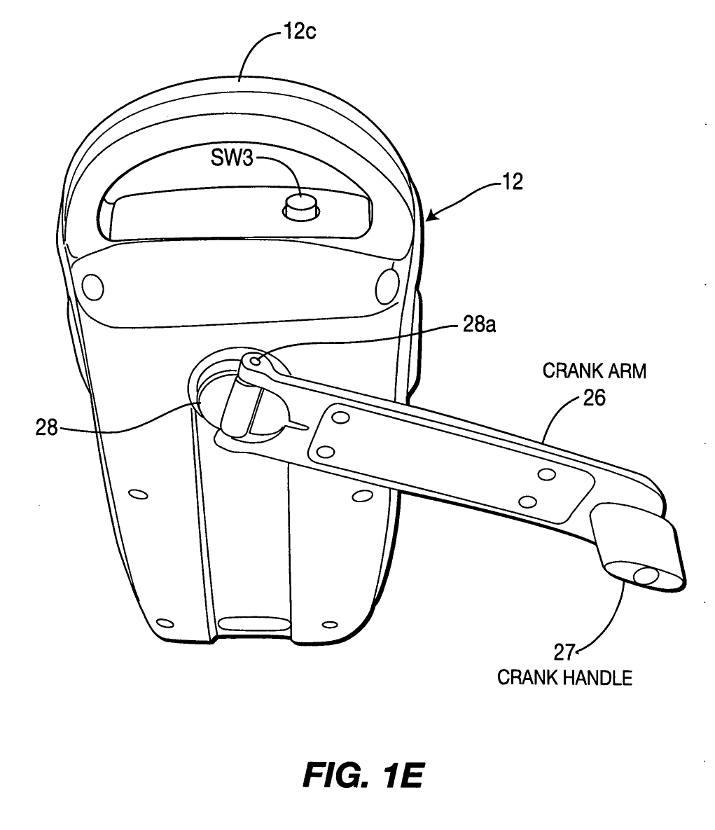

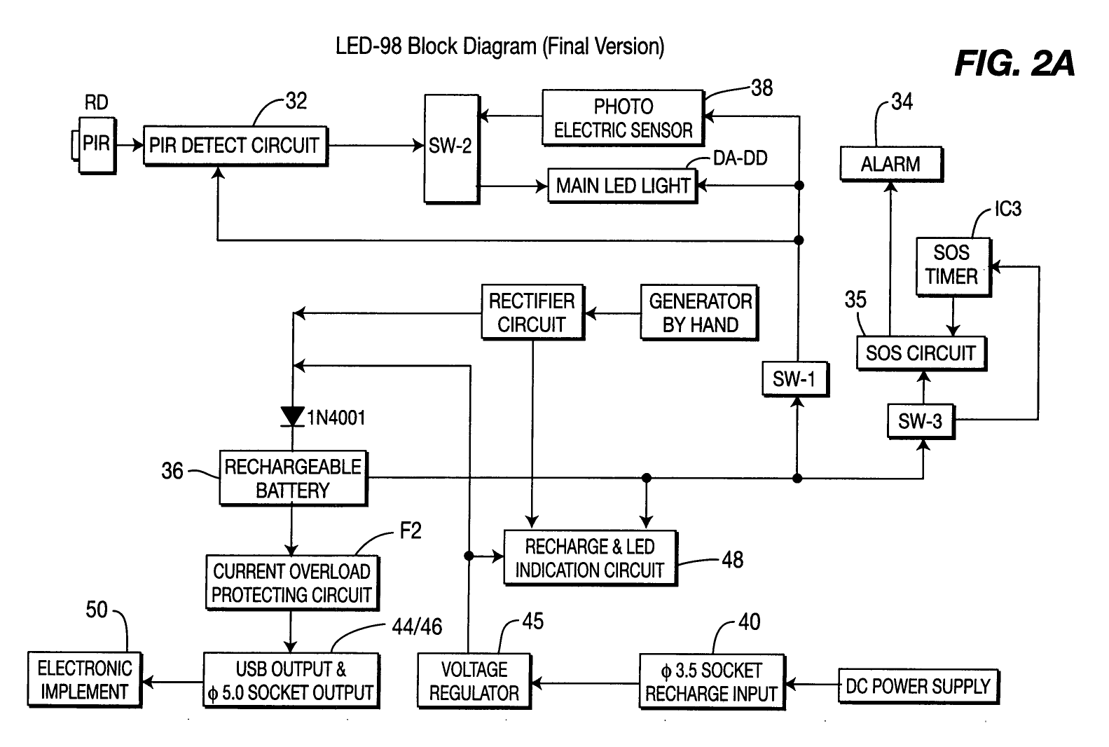

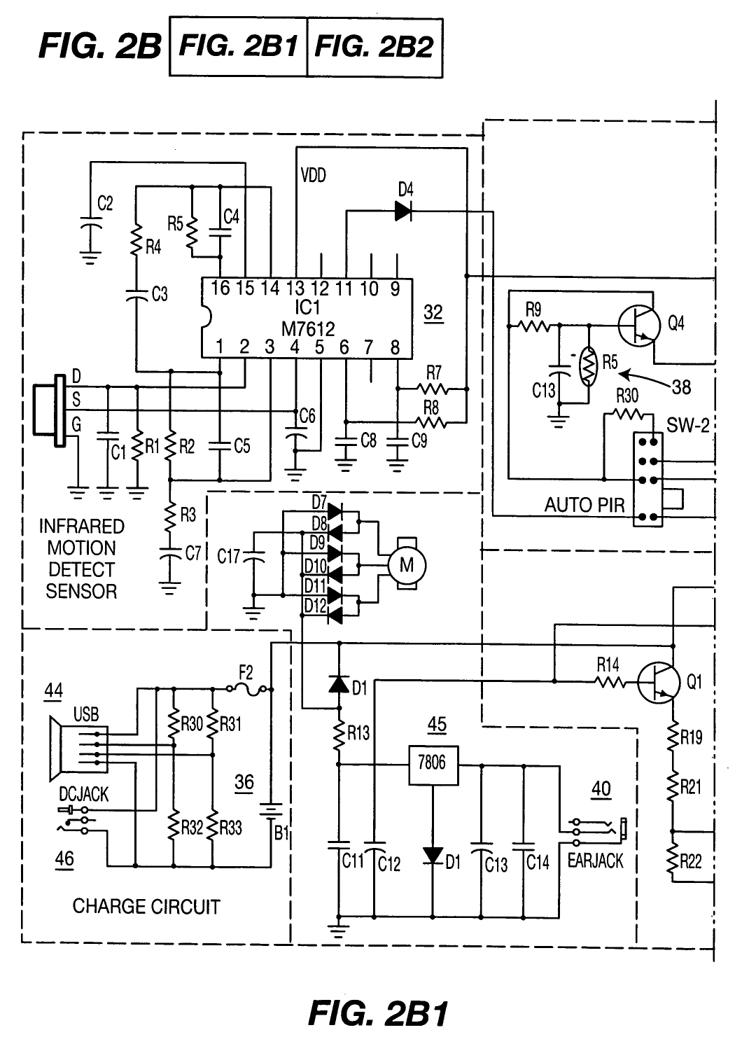

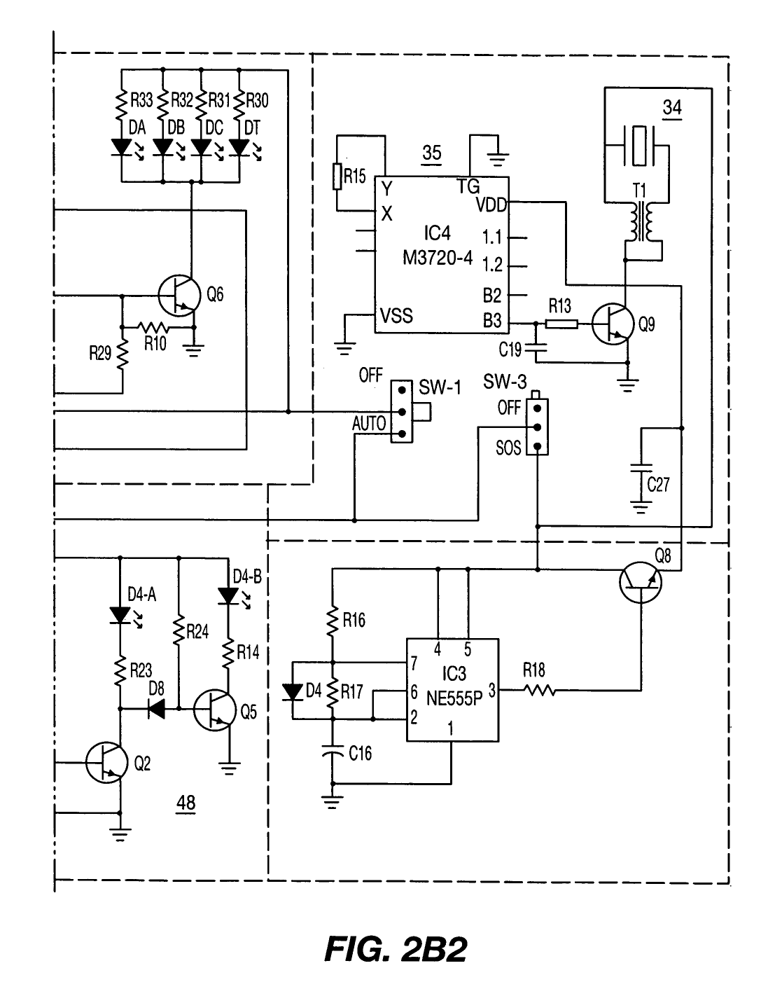

FIGS. 1A to 1E show one preferred embodiment 10 of the present invention comprised of a housing 12 having openings 12a and 12b along the front face thereof, opening 12a being covered with a translucent cover window 14 for covering and protecting a motion sensing element RD to be described below in detail and shown in FIG. 2B.

A transparent window 16 seals opening 12b and protects the plurality of LEDs DA thru DD to be described below in detail and likewise shown in FIG. 2B.

The upper end of housing 12 is provided with a substantially semi-circular-shaped integral handle 12c to facilitate handling and transportation of device 10 as well as enabling the device to easily mounted upon a suitable support such as a hook, projection, and the like, greatly facilitating the use of device 10, especially in outdoor environments. A top surface 12d of housing 12 is provided with substantially circular shaped openings 12e-12f each sealed with a protective lens 18, 20 respectively, which protective transparent lenses cover indicator LEDs D4-A and D4-B and light sensor CDS shown in FIG. 2B and to be described in detail below.

Push button switch SW3 (see also FIGS. 2 and 2A) operates the “SOS alarm” as will be described below.

The right-hand side of housing 12 is provided with a slide switch SW1, which operates the power on or off. Left-hand switch SW-2 controls the light functions. When SW1 is in the off position, SW-2 is automatically disabled.

A USB output port is positioned behind a cover member 22 covering the connector (not shown) to protect the connector from the elements, when not in use. Cover member 22 is preferably a rubber or rubber-like resilient, flexible member having one end secured to the housing and configured to snap-fit over the USB connector port to protect the connector from the elements and make it splash proof. An opening 12g in the right-hand sidewall of housing 12 is provided with a connector for receiving the output of a DC power source coupled thereto by a suitable cable (not shown for purposes for simplicity).

The left-hand side of housing 12 is provided with slide switch SW2 to select all of the light functions (night/on/motion), as will be more fully described below. The left-hand side of housing 12 is further provided with a flexible protective cover 24 similar to protective cover 22 for protecting the DC 9V input connector (not shown for purposes for simplicity) and, when closed, serves to protect the connector from the elements and to make it splash proof.

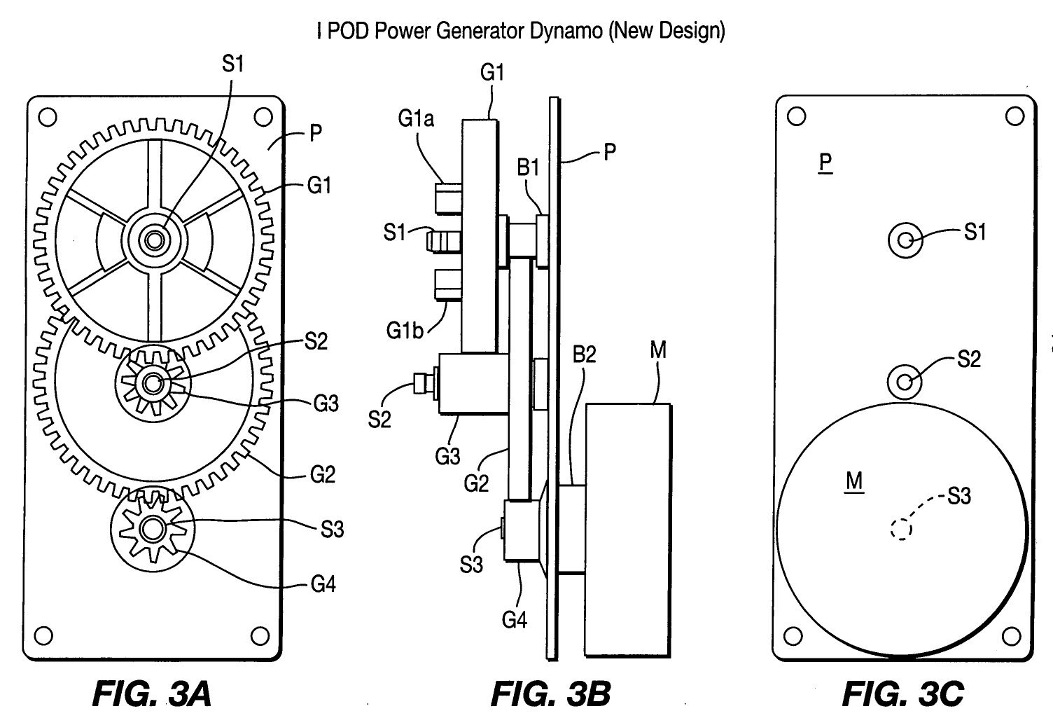

A manually-operated hand crank is mounted along the rear surface of housing 12 and includes a crank arm 26 rotatably coupled to an electric power generator shown in FIGS. 3B and 3C as well as the schematic diagram shown in FIG. 2B.

The crank arm 26 is pivotally mounted at one end to rotatable member 28 by means of a pin (not shown) extending through openings in the bifurcated arms 26a, 26b of crank 26 as well as an opening in a projection 28a provided along the exposed surface of rotatable member 28 and positioned between bifurcated arms 26a, 26b. The pivot pin allows the crank arm 26 to swing from a stored position, shown in FIG. 1C in which it is held within a shallow recess 12h provided along the rear surface of housing 12, shown in FIG. 1E. The crank arm 26 is further provided with a gripping handle 27 which facilitates cranking of the electrical power generator M by rotation of crank arm 26. Operating handle 30 is positioned within a recess 12i when not in use. FIG. 1C showing the crank arm 26 and handle 27 in the stored, inoperative position and FIGS. 1D and 1E show the crank arm in readiness for cranking.

Making reference to FIGS. 3A-3C, the rotatable member 28, shown in FIG. 1C, is mechanically coupled to a shaft S1 mounted to freely rotate within a bearing B1 on mounting plate P. Member 28 is provided with recesses (not shown) which receive projections G1a, G1b integrally joined to one side surface of circular gear G1. A second gear assembly, comprised of a large diameter gear G2 and a small diameter gear G3 integrally joined to gear G2, are mounted to rotate about a fixed shaft S2 secured to mounting plate P. Small gear G3 meshes with large gear G1. Gear G4 is fixably mounted to shaft S3 and meshes with gear G2. Shaft S3 is journaled within a bearing B2 on plate P to rotate freely while being fixed to gear G4 and coupled to and serving as the means for driving the rotor (not shown) of electrical generator M.

A significant mechanical advantage is obtained by the gear ratios G1/G3 and G2/G4 to provide adequate AC power from the electrical generator M. In the example shown in FIG. 3A, the gear ratio is of the order of 20:1.

Making reference to FIGS. 2A and 2B, the simplified block diagram of FIG. 2A is comprised of a passive infra-red PIR detection circuit 32 which is preferably a model M7612 integrated circuit controller device (IC1) utilizing an analog mixing, digital design and thus providing a highly stable PIR controller. However, any other controller having like capabilities may be used. Depending upon the positions of switches SW2 and SW1, the controller circuit IC1-32, upon detection of motion by motion detector RD, selectively illuminates LEDs DA thru DD. The alarm device 34, which is operated by an SOS circuit which may be a conventional siren generator integrated circuit (IC4) such as a model M3720-4. However, the alarm power on or off is controlled by push button-type SW3, which directly couples battery source 36 to SOS circuit 35 and SOS timer IC3 (NE 555P).

Controller IC1-32 derives power from the battery source 36 coupled to pin 13 of controller IC1. When the sensor RD senses motion, an output of a given level appears at terminal 11 of controller IC1, which is coupled to the collector and base electrodes of transistor Q4 through diode D5 and switch SW2, when moved to the Automatic mode.

When ambient light is above a given threshold, transistor Q4 is turned off thereby turning off transistor Q5. Although the positive terminal of battery 36 is coupled to LEDs D4-DD, they remain off.

Power from the battery 36 is selectively coupled through transistor Q8 to the VDD terminal of siren circuit M3720-4 (IC-4), when switch SW3 is pressed, to turn on transistor Q9 and thereby operate the siren generating member 34 through transformer BT1.

When the switch SW3 is pressed in, battery 36 is coupled through switch SW3 to input terminal 7 of the timer circuit IC3 which is preferably a conventional timer and may, for example be a NE555P integrated circuit (IC3) which is turned on for a given interval as determined by the values of resistor R17, capacitor C16 and diode D4, selectively controlling transistor Q8, whose collector electrode is coupled to the positive terminal of battery 36, to couple battery 36 to the VDD terminal of siren circuit IC4, which remains on for a given time determined by the aforementioned components R17, C16 and D4, coupled to timing circuit IC3. It should be noted that the SOS switch SW3 is pressed and then released. Let the timing circuit IC3 remains on, however, the emitter electrode of transistor Q8 being directly connected to the VDD terminal of alarm circuit IC4.

The LEDs DA-DD may be controlled to turn on when the light sensor element (CDS) 38 senses a drop in ambient light, such as may occur at sundown, when out of doors, or as may occur indoors at sundown or when a power failure of conventional AC power occurs. When switch SW1 is in the “ON” position and SW2 is in “NIGHT” position, light sensor 38 detects reduction in ambient light below a given threshold level, whereby transistors Q4 and Q5 are turned on to turn on LEDs DA thru DD.

The DC power connector 40 receives input power from a DC adaptor (i.e. an AC/DC converter, which outputs are typical of the order of 9 volts DC), voltage regulator 45 converting this 9 volts DC input into a highly regulated DC output of the order of 5 volts, and connects the regulated DC output to the connectors 44 and 46 through diode D1, resistor R13 and protective fuse F2. In addition, rechargeable battery 36 couples this output, which is typically 5 volts DC, to the VDD terminals of USB connector 44 and the DC jack connector 46 through the protective fuse F2. The output of voltage regulator 45, is connected in common to resistor R13 and diode Dl to charge rechargeable battery 36. The voltage regulator, which is preferably a 7806 IC voltage regulator which, in cooperation with resistor R13 (having a resistance of the order of 10ohms, and a rating of 0.5watts) assures “slow charging” of the rechargeable battery to significantly prolong the useful operating life of the battery.

As was described above, the backup energy device 10 further includes an electric power generator M for generating AC power by operation of the hand crank 26. The output of power generator M is coupled through a diode bridge comprised diodes D7 thru D12. Diodes D8, D10 and D12 have their electrodes coupled in common to one terminal of resistor R13 and the anode electrode of diode Dl. Filter capacitors C11 and C12 are coupled in parallel between resistor R13 and ground. Generator M provides power to the USB output connector 44 and DC jack connecter 46 through diode D1 and protective fuse F2.

Summarizing the operation of the first embodiment 10, when it is desired to provide backup power for an electronic implement, making reference to FIGS. 2A and 2B, the electronic implement, which may be a cell phone, PDA, Blackberry, ipod, PSP, or the like, is connected to one of the power outputs 44 or 46 by a suitable conventional connecting cable, not shown. A recharge and LED indication circuit 48 comprised primarily of LEDs D4-A and D4-B and transistors Q1, Q2 and Q3, provide for illumination of LED D4-A to indicate that a charging operation is taking place. LED D4-B is visible through the viewing window 18, FIG. 1A. When battery 36 is fully charged, transistor Q1 turns on, causing transistor Q2 to turn on illuminating LED D4-A indicating that the battery is fully charged. In addition, transistor Q2 couples ground potential to the collector electrode of transistor Q3 through diode D3 to turn off LED D4-B, indicating that the battery voltage is about 5.2V DC. Even though the charge indicator turns green, the charging operation preferably should continue for a period of the order of 12 hours in order to assure that the battery is fully charged.

When power is provided at input power jack 40, the recharging LED indication circuit 48 is powered by the output of the voltage regulator 45 which is directly coupled to the anode electrodes of LED D4-A and D4-B and is coupled to the base electrode of transistor Q1 by resistor R14.

In the event that rechargeable battery 36 is no longer capable of powering an electronic implement due to the depletion of energy stored therein, the electric generator M develops AC power by rotation of the crank arm 26. The AC power is converted to DC by the diode bridge comprised of diodes D7 thru D12, the output of which is coupled to output connectors 44 and 46 through diode D1 and fuse F2. Energy developed by the generator is stored in rechargeable battery 36. This energy is also available to the LEDs DA thru DD thereby providing emergency power for the flashlight LEDs DA-DD, as well as providing power for the controller IC1. Two (2) minutes of cranking provides at least six (6) minutes of cell phone talk time or 30 minutes of illumination of the LED light as well as being capable of directly recharging a cell phone battery. The rechargeable battery 36, when fully charged, holds its charge for more than two (2) weeks. This is obtained through the use of diode D1.

The motion detector RD and PIR detect circuit 32 can activate the LEDs DA-DD when someone or something approaches the unit, with the SW1 in the “ON” position and switch SW2 in the “MOTION” position. The SOS circuit 35 provides an SOS signal to set off alarm 34 when push button switch SW3 is pressed in. When SW1 is “ON” and SW2 is in the “NIGHT” position, ambient light sensor 38 automatically turns on the flashlight LED's DA-DD when ambient lights drops below a given level, which is an adjustable value determined by the resistance values of ambient light detector 38 (which typically varies over a range of the order of 10³ ohms to the order of 0.7×10⁶ ohms for one typical cadmium sulphide photocell) and resistor R9, series coupled between the collector electrode of transistor Q4 and ground. The common terminal of resistor R9 and light sensor 38 are coupled to the base electrode of transistor Q4.

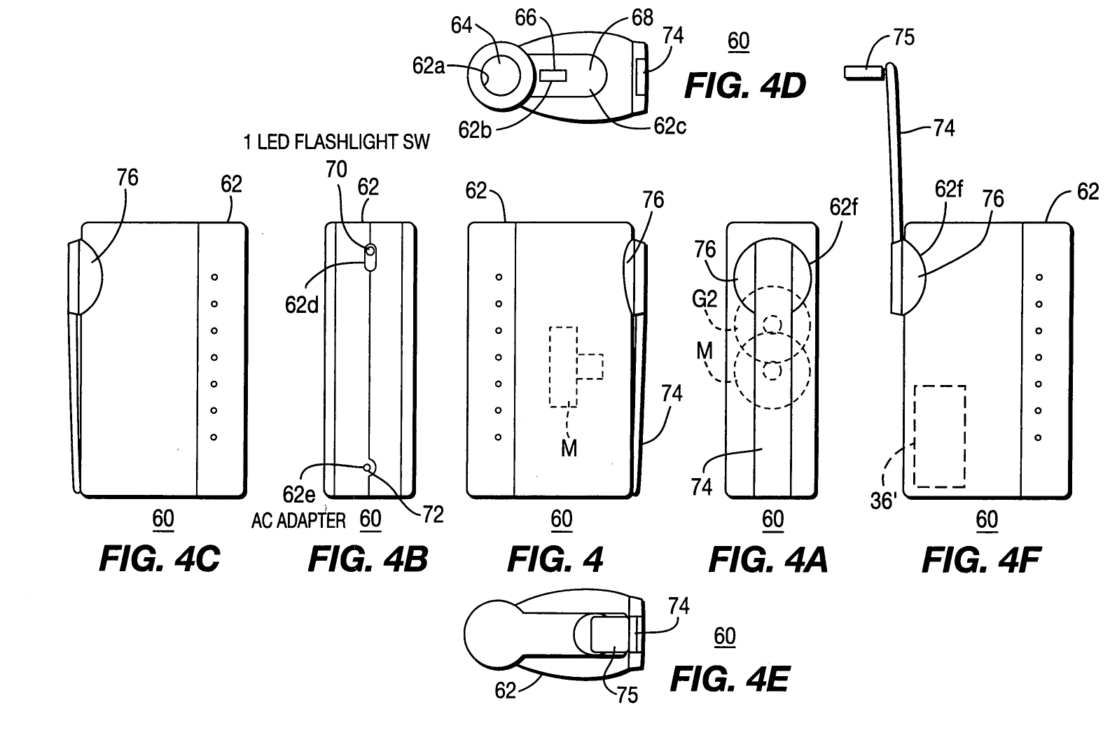

FIGS. 4 thru 4F show another preferred embodiment 60 of the present invention comprised of a housing 62 with an opening 62A along the top surface thereof and fitted with a transparent lens 64 for emitting light from a LED flashlight. An opening 62b is provided for a USB output connector 66. Charging indicator LED 68 is visible through an opening 62c along the top surface of housing 62. An operating LED flashlight slide switch 70 protrudes through an elongated opening 62d near the top of a front end of the housing. An AC adaptor input 72 is accessible through opening 62e near the bottom of the front end of the housing 62. A rear surface of the housing is provided with a crank arm 74 having an operation handle 76 rotatably connected to a free end of crank arm 74. The opposite end of crank arm 74 is pivotally connected to rotatable member 76 arranged to rotate within a circular opening 62f along the rear wall of housing 62. The crank arm 74 operates in a manner similar to that shown in FIGS. 1A thru 1E. The operating handle 76 is seated within a recess 62g along the bottom end of housing 62 when the crank arm is not in use.

Member 76 is rotated by crank arm 74 to operate the electric generator, A mechanical advantage is derived from the gear assembly comprised of gears G1-G4 which are substantially identical in design and function to the drive gears shown in FIGS. 3A-3C for the purpose of driving the power generator M. The rechargeable battery source in housing 62 is preferably a rechargeable battery 36′, shown in dotted fashion in FIG. 4F.

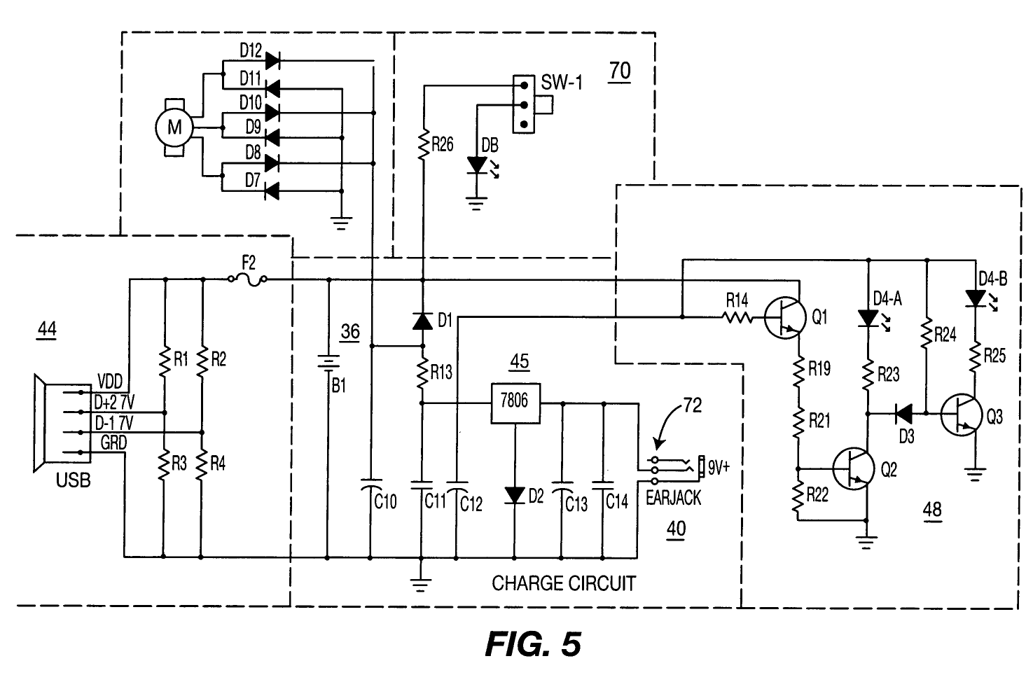

FIG. 5 is a schematic diagram of the electronics provided within the power bank where in like elements have been designated by like numerals, making reference to the schematic diagram shown in 2B.

Electric generator M provides an AC output when crank arm 74 is rotated, the diode bridge comprising diodes D7-D12 serving to convert the AC output of the electrical generator to DC and couple the DC output through diode D1 and resistor R26 to LED DB when switch 70 is closed. The DC output from the diode bridge is also coupled to the rechargeable battery 36′ and is further directly connected to the USB output power connector 44 through diode D1 and fuse F2.

The 9 volt DC input 40 is coupled to USB output power connector 44 through voltage regulator 45, the output of which is connected in common to the USB output power connector 44 through R13, D1 and F2 and to LED DB through resistor R13, diode D1 and resistor R26, when switch 70 is closed, as well as providing power to the charging indicator LEDs D4-A and D4-B.

The operation of the electronic circuitry of embodiment 60 is substantially identical to the operation of the electronic circuit in embodiment 10 in that rechargeable battery 36 may be charged through power input connector 40 which receives DC power of approximately 9 volts either from a DC adaptor (i.e. an AC/DC converter) or DC power from an automobile outlet such as a cigarette lighter socket, which is then converted to highly regulated DC of the order of 5 volts by voltage regulator 45 to apply 5 volts DC to battery 36, as well as USB power output connector 44 and flashlight LED DB.

When the energy in battery 36 is low or depleted, and battery 36 is being charged, transistor Q1 is turned off to turn off LED B4-A and turn on LED B4-B providing an indication that the rechargeable battery 36 is being charged. When the battery is fully charged, transistor Q1 is turned on, causing transistor Q2 to be turned on to illuminate LED D4-A and thereby turn off transistor Q3 to turn off D4-B.

A wide variety of adapters are usable with the USB connector 44 to provide charging for a variety of different portable, chargeable electronic devices.

The embodiments of the present invention thus provide a novel, portable power backup device for portable electronic devices and which are capable of storing energy for later use to power portable electronic devices as well as being capable of generating energy through use of a fully contained manually operable power generator which may either store power which it generates or directly provide power to a portable electric device coupled thereto.

What is claimed is:

1. A portable unit for powering portable devices which operate on dc power comprising:
a housing containing:
a rechargeable battery;
an electric generator for generating an AC output;
a rectifier for converting the AC output to a DC output;
a USB power output connector; and
a voltage regulator integrated circuit (IC) coupled between a DC input power connector for providing DC power to said output power connector;
said battery being selectively recharged by one of said electric generator and voltage regulator.

2. The unit of claim 1, further comprising:
a manually operable crank assembly for driving said generator.

3. The unit of claim 2, wherein said crank assembly comprises;
a crank arm manually coupled to a rotatable member driving said generator when said arm is rotated.

4. The unit of claim 3 wherein a free end of said crank arm is provided with a mounted handle;
said handle and arm being moveable between an operating position for cranking and a stored position retained in a recess arranged along an exterior of said housing for respectively receiving at least one of said crank arm and handle to provide a compact unit to facilitate handling and storage of said unit.

5. The unit of claim 1, said housing having an integral, arcuate-shaped handle at one end thereof to facilitate both handling and support of said unit.

6. The of claim 5 further comprising:
a motion sensor device;
a switch accessible from an exterior surface of said housing and movable between a first position for deactivating said sensing device and a second position for activating said sensing device;
said sensing device illuminating a light source when activated and responsive to detection of motion.

7. The unit of claim 6 wherein said light source comprises at least one light emitting diode (LED).

8. The unit of claim 5, further comprising:
a light sensing device;
a switch movable between a first position deactivating said light sensing device and a second position activating said device, said sensing device illuminating a light source when activated and responsive to reduction of ambient light below a given level.

9. The unit of claim 5, further comprising;
a switch movable between a first position deactivating an SOS alarm device and a second position activating said device;
said device generating an audible alarm when activated.

10. The unit of claim 9, comprising:
a timer activated when said switch is in said second position to control said audible alarm to remain activated for a given time interval.

11. The unit of claim 9, said switch being movable to a second position for activating a flashlight light.

12. The unit of claim 11 wherein said light comprises at least one light emitting diode (LED).

13. The unit of claim 1, further comprising:
resilient covers for removably covering said input and output connectors to prevent entry of foreign matter.

14. The unit of claim 13, wherein said covers are joined at one end to said cover and are movable between a first position covering their associated connector and a second position uncovering their associated connector.

15. The unit of claim 14, wherein the flexible covers are snap-fitted to the housing when in the covering position.

16. The unit of claim 1, further comprising:
a rotatable crank assembly for manually rotating a rotor provided in said generator;
a multiple gear assembly arranged between said crank assembly and said rotor for providing a mechanical advantage to increase a number of rotations per unit time at said rotor to a given multiple of rotations per unit time of said manually operable crank assembly.

17. The unit of claim 16, said gear assembly comprising:
a mounting plate;
a first circular gear secured to a first shaft rotatable mounted in a bearing mounted on said plate;
second and third circular gears rotatably mounted on a second shaft, said second gear having a diameter less than said first and third gears and having gear teeth meshing with gear teeth of said first gear;
a fourth gear fixed to a third shaft rotatably mounted in a second bearing on said plate;
said generator being mounted on a side of said plate opponent said gears;
said third shaft being coupled to drive said rotor;
said fourth gear having a diameter less than said second gear and having gear teeth meshing with gear teeth of said third gear.

18. The unit of claim 16 wherein the gears of said gear assembly are configured to provide a gear ratio of the order of 20:1.

19. The unit of claim 16 wherein said first and third gears partially overlap one another to provide a compact gear assembly and thereby provide a more compact unit.

20. The unit of claim 1 wherein charging of the rechargeable battery is performed at a slow rate through use of the voltage regulator configured to provide a regulated output of the order of a voltage rating of the rechargeable battery.

21. The unit of claim 20 further comprising providing a resistor coupled between the output of the voltage regulator and the rechargeable battery and having a resistance of the order of 10 ohms.

22. The unit of claim 1 further comprising provides a diode between a positive terminal of said rechargeable battery and ground potential and being poled to enable the battery to maintain its charge for an increased period of time.

23. A portable unit for powering portable devices which operate on dc power comprising:
a housing containing:
a rechargeable battery;
an electric generator for manually generating an AC output;
a rectifier for converting the AC output to a DC output;
a USB power output connector; and
a voltage regulator integrated circuit (IC) coupled between a DC input power connector for providing DC power to said output power connector;
said rechargeable battery being selectively charged by one of said electric generator and DC 9V input port.

24. The unit of claim 23 wherein said battery is coupled to said USB output connector for charging a battery of a portable device coupled to said USB output connector.

25. A portable unit for powering portable devices which operate on dc power comprising:
a housing containing:
a rechargeable battery;
an input port for coupling to a source of power of the order of 9 volts DC;
a manually operable electric generator for generating an AC output;
a rectifier for converting the AC output to a DC output; and
a USB power output connector;
said rechargeable battery being selectively charged by one of said electric generator and power coupled to said input port.

26. The unit of claim 25 wherein said battery is coupled to said USB output connector for charging a battery of a portable device coupled to said USB output connector.
